(19) United States
(12) Patent Application Publication
(10) Pub. No.: US 2009/0092254 A1
(43) Pub. Date: Apr. 9, 2009

(54) METHOD FOR EFFICIENTLY PROVIDING KEY IN A PORTABLE BROADCASTING SYSTEM AND SYSTEM USING THE SAME

(75) Inventors: Kyung-Shin LEE, Suwon-si (KR); Young-Jip Kim, Suwon-si (KR); Joon-Ho Park, Suwon-si (KR); Ji-Wuck Jung, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 12/248,555

(22) Filed: Oct. 9, 2008

(30) Foreign Application Priority Data
Oct. 9, 2007 (KR) 2007-0101456

(51) Int. Cl. H04L 9/00

(52) U.S. Cl. 380/278

(57) ABSTRACT

A method for efficiently providing a key in a portable broadcasting system and a system using the same are provided, in which when a user selects a service to be purchased after invoking a broadcasting application, a terminal transmits a service request message including information about the selected service, a server transmits a service response message including a key required for using the selected service in the form of a MIKEY, and the terminal receives the service response message.

### PRIORITY

This application claims priority under 35 U.S.C. § 119(a) of a Korean Patent Application filed in the Korean Intellectual Property Office on Oct. 9, 2007 and assigned Serial No. 2007-101456, the entire disclosure of which is hereby incorporated by reference.

### BACKGROUND OF THE INVENTION

1. Field of the Invention

The present invention generally relates to a portable broadcasting system. More particularly, the present invention relates to a method for efficiently providing a key in a portable broadcasting system and a system using the same.

2. Description of the Related Art

The Open Mobile Alliance (OMA) is an organization that works on standardization of inter-operability among individual mobile solutions. The OMA mainly establishes standards for various applications including mobile communication gaming and Internet service. In particular the OMA Broadcast (BCAST) Working Group is studying a technology for providing broadcasting service through mobile terminals.

Hereinbelow, a portable broadcasting system discussed by the OMA will be briefly described. While the following description is made in the context of OMA BCAST, a portable broadcasting technology standard which is a specific example for describing a conventional technology and the present invention, it does not limit the present invention.

Recently, great progress has been made in setting the Service & Content Protection (SPCP) standard that the OMA BCAST is working on, and the availability of the Candidate 1.0 version was announced in Jul. 12, 2007. The SPCP standard defines service protection and service access that are closely related to a business model, for a portable broadcasting service.

For instance, when a user accesses or selects a paid service through his mobile terminal, he should go through the following seven steps in order to receive the paid service. The steps will be described below with reference to FIGS. 1A and 1B. FIGS. 1A and 1B are diagrams illustrating a conventional message flow between a terminal and a server, for key acquisition.

Referring to FIG. 1A, when a user invokes a broadcasting application (for example a TV application) in step 100, he can purchase an intended service. When the user requests service purchase, a terminal 10 starts to purchase the service in step 101. To do so, the terminal 10 transmits a Service Request message including an Identifier (ID) of the service to a server 20 in step 102. In step 103, authentication is performed between the terminal 10 and the server 20. The server 20 then transmits a Service Response message to the terminal 10 in step 104. The Service Response message includes information indicating whether the service purchase is successful or failed. If the Service Response message indicates the successful service purchase, the service is charged. Step 100a is a service purchase step in FIG. 1A.

In step 106, the terminal 10 opens the User Data Protocol (UDP). When the UDP is open, the server 20 transmits a Multimedia Broadcast/Multicast Service (MBMS) Service Key (MSK) in the form of a Multimedia Internet KEYing (MIKEY) by UDP PUSH (User Datagram Protocol Push) to the terminal 10 in step 108. When the TV application ends or immediately before the power of terminal 10 is turned off in step 110, the terminal 10 transmits a Deregistration Request message to the server 20 in step 112. That is, when the user wants to end the TV application or the terminal 10 is power-off, deregistration is required. The Deregistration Request message indicates to the server 20 that the terminal 10 does not need to receive an MSK any longer, and includes IDs of all services that have been registered successfully. After authentication in step 113, the terminal 10 receives a Deregistration Response message from the server 20 in step 114 and closes the UDP in step 116. Step 110b is a deregistration step in FIG. 1A.

Referring to FIG. 1B, when the user invokes the TV application again or turns on the terminal 10 in step 108, registration should be performed for the already purchased service. Thus, the terminal 10 transmits a Registration Request message to the server 20 in step 120. The Registration Request message indicates that the terminal 10 is ready to receive an MSK by the UDP and includes the IDs of already purchased services. After authentication in step 121, the terminal 10 receives a Registration Response message from the server 20 in step 121. Step 100c is a service registration step in FIG. 1B.

While the services are registered as described above, the terminal 10 opens the UDP in step 124. As long as the terminal 10 maintains a Packet Data Protocol (PDP) Context, it receives an MSK in the form of a MIKEY by the UDP PUSH each time the server 20 updates the MSK in steps 126 and 128.

In an exceptional case where the terminal 10 fails to receive a necessary MSK, an MSK request step should be performed. Hence, the terminal 10 can request the MSK directly to the server 20. To do so, the terminal 10 transmits an MSK Request message including the D of the MSK to the server 20 and the server 20 replies with an MSK Response message. If this procedure is successful, the terminal 10 can receive the MSK in the form of a MIKEY from the server 20 by the UDP PUSH.

As described above, besides the service purchase step, the service registration step, the key request step, and the deregistration step, a purchase cancel step, a Short Message Service (SMS) trigger step, and Web-based purchase step are also required to receive a paid service.

In the purchase cancel step, the terminal transmits Unsubscribe Request message including the ID of a service to be canceled to the server. The server replies to the terminal with an Unsubscribe Response message. If this procedure is successful, the ID of the canceled service is not used during the subsequent registration and deregistration.

In the SMS trigger step, when a current MSK is changed or the PDP Context is not valid, the server can notify the terminal of the fact by an SMS message.

In the Web-based purchase step, when the terminal wants to purchase a service on the Web, it receives a Smart Card Profile Trigger message, thus completing the purchase. Then, the terminal should register using information included in the Smart Card Profile Trigger message. If the registration is successful, the terminal can receive an MSK by the UDP.

As described above, the conventional Smart Card Profile uses the UDP PUSH to transmit an MSK. In this scheme is for the server pushes an updated MSK to the terminal whenever the MSK is updated. However, the terminal should perform the following procedure in order to acquire the MSK by the UDP PUSH.

First, the terminal notifies the server that it is ready to receive an MSK during registration. As long as the terminal maintains the PDP Context, the server transmits the MSK in the form of a MIKEY to the terminal by the UDP. Later, the terminal notifies the server that it does not need to receive the MSK any longer during deregistration.

Registration is required when the terminal is powered-on or a TV application starts, and deregistration is needed when the terminal is powered-off or the TV application ends. Moreover, the terminal should maintain the PDP Context until deregistration takes place after registration. If a service charge is billed based on a usage time, the terminal is continuously charged. As a matter of fact, the MSK is updated every few hours in the case of a short update period or monthly in the case of a long update period. Hence, maintaining the PDP Context for the MSK update is very inefficient because it consumes network resources. Also, in terms of security, the long connected state makes the terminal vulnerable to security attacks.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide a method for efficiently providing a key in a portable broadcasting system and a system using the same.

Another aspect of exemplary embodiments of the present invention provides a method for providing a key fast by skipping unnecessary key acquisition steps in a portable broadcasting system and a system using the same.

In accordance with an aspect of exemplary embodiments of the present invention, there is provided a method for efficiently providing a key in a portable broadcasting system having a terminal and a server, in which the terminal transmits a service request message including information about the selected service, the server transmits a service response message including a key required for using the service in the form of a MIKEY, and the terminal receives the service response message.

In accordance with another aspect of exemplary embodiments of the present invention, there is provided a portable broadcasting system for efficiently providing a key, in which when a user selects a service to be purchased after invoking a broadcasting application, a terminal transmits a service request message including information about the selected service, and a server transmits a service response message including a key required for using the service in the form of a MIKEY to the terminal.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIGS. 1A and 1B are diagrams illustrating a conventional message flow between a terminal and a server, for key acquisition

FIG. 2 is a diagram illustrating a message flow between a terminal and a server, for key acquisition according to exemplary embodiments of the present invention;

FIG. 3 illustrates a MIKEY format according to an exemplary embodiment of the present invention;

FIG. 4 illustrates an encoded MIKEY in a Service Response message according to an exemplary embodiment of the present invention; and

FIG. 5 illustrates an encoded MIKEY in a MSK Response message according to an exemplary embodiment of the present invention.

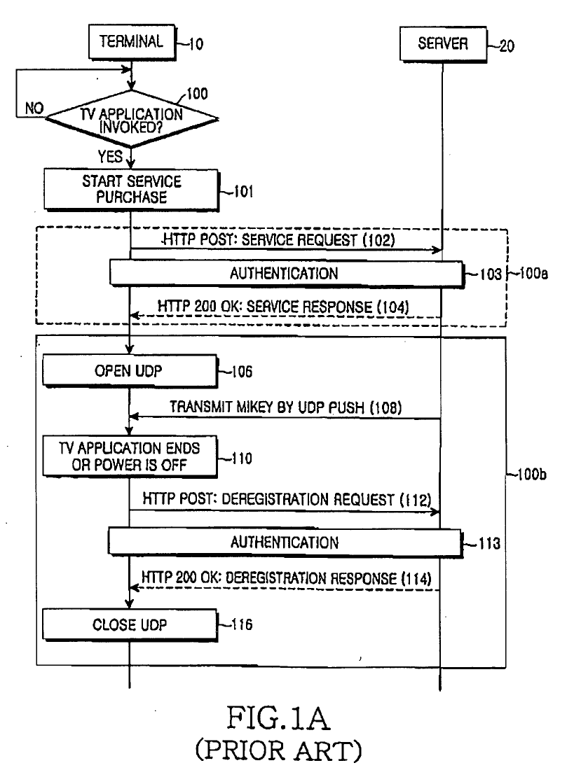

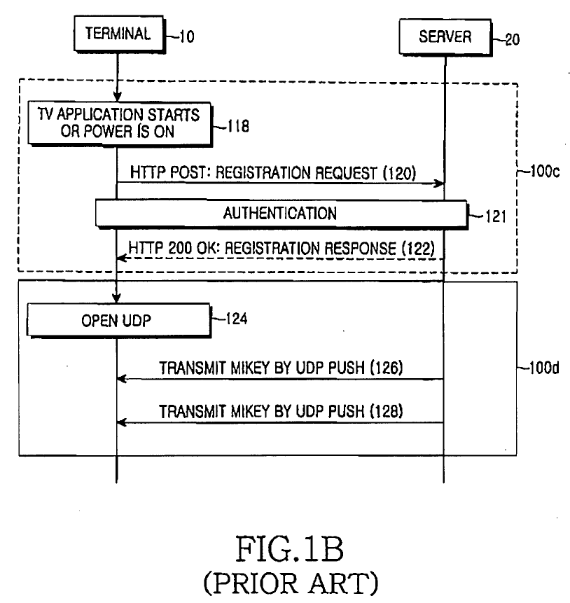

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide an efficient key and method using the same in a portable broadcasting system. In accordance with an exemplary embodiment of the present invention, when a terminal transmits a Service Request message to purchase a service, a server transmits a necessary MSK for the service to the terminal by a Service Response message. In accordance with another exemplary embodiment of the present invention, if an MSK is updated, the server notifies the terminal that there is an MSK to be updated by an SMS message and upon receipt of an MSK Request message from the terminal, provides the updated MSK to the terminal by an MSK Response message. In accordance with a third exemplary embodiment of the present invention, when the terminal autonomously transmits an MSK Request message, the server transmits an MSK to the terminal by an MSK Response message.

Since the server transmits an MSK by an MSK Response message, and not by the UDP in the above manner, the MSK is provided quickly to the terminal. Also, since the terminal can receive the MSK without keeping a PDP Context, it avoids an unnecessary service charge.

The following description is made of the exemplary embodiments of the present invention. While names used in the OMA BCAST Smart Card Profile are still used herein for convenience, they do not limit the present invention and the present invention is applicable to any system with a similar technological background.

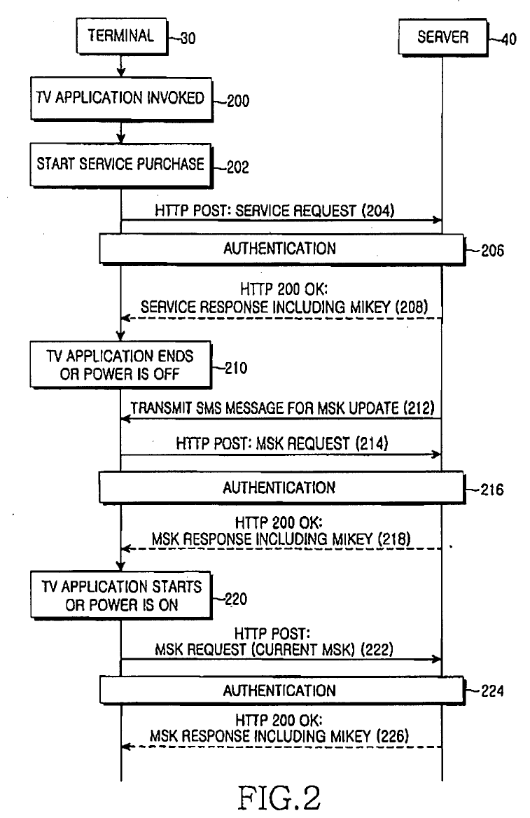

With reference to FIG. 2, the exemplary embodiments of the present invention will be described. FIG. 2 is a diagram illustrating a message flow between a terminal and a server, for key acquisition according to an exemplary embodiment of the present invention.

Steps 200 to 208 corresponding to a first exemplary embodiment of the present invention will first be described. When a user invokes a TV application, a terminal 30 starts the TV application in step 200. Then the user selects an intended service to be purchased and the terminal 30 starts the service purchase in step 202. Hence, the terminal 30 transmits a Service Request message including an ID of the intended service to a server 40 by the Hypertext Transfer Protocol (HTTP) in step 204. In step 206, authentication takes place between the terminal 30 and the server 40. Regarding authentication, upon receipt of a Service Request message, the server 40 requests additional information to the terminal 30 by the HTTP, that is, by HTTP 401 WWW-Authenticate. Then the terminal 30 transmits a Service Request message including the additional information to the server 40 and the server 40 authenticates the terminal 30 using the additional information.

When authentication is completed, the server 40 transmits a Service Response message including an MSK in the form of a MIKEY to the terminal 30 in step 208. This Service Response message is also transmitted by the HTTP. In this manner, the terminal 30 and the server 40 exchange their messages on an interactive channel. The MSK in the form of the MIKEY is required for the user to use the purchased service. The MSK is base64-encoded in the Service Response message, which will be described later. Also, the Service Response message includes information indicating whether the service purchase is successful or failed. If the Service Response message indicates a successful service purchase, a service charge is billed. After the service purchase, the terminal 30 does not need to deregister when the user ends the TV application or turns off the terminal 30 in step 210. Hence, as the server 40 transmits the MSK at one time by the Service Response message without using the UDP and the unnecessary deregistration is skipped, the overall process becomes fast.

Steps 200 to 208 correspond to an MSK acquisition for an initial service purchase. If the MSK is updated or changed after the initial service purchase, the MSK is acquired as follows.

In accordance with a second exemplary embodiment of the present invention, when the MSK is updated or changed after the initial service purchase, the server 40 allows the terminal 30 to acquire the latest MSK. To do so, the server 40 transmits an SMS message for MSK update to the terminal 30 in step 212. Although a conventional SMS message is used to command a connection retry when a PDP Context is not valid, the SMS message indicates the presence of an MSK to be updated in the second exemplary embodiment of the present invention. Therefore, the SMS message includes an ID of the MSK that the terminal 30 should update. Upon receipt of the SMS message, the terminal 30 is aware that there is a new MSK to be received and also which MSK to receive. In step 214, the terminal 30 transmits an MSK Request message including the ID of the MSK to the server 40 in order to request the MSK indicated by the server 40.

Authentication is performed between the terminal 30 and the server 40 in the same manner as step 206 and thus its detailed description is not provided herein. After the authentication, the server 40 transmits an MSK Response message including the MSK corresponding to the MSK ID in the form of a MIKEY to the terminal 30 in step 218.

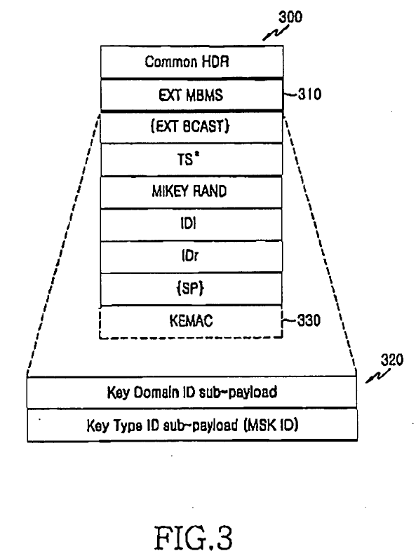

The MSK is efficiently formatted by binary coding such as MIKEY. The MIKEY has a configuration indicated by reference numeral 300 in FIG. 3. FIG. 3 illustrates a MIKEY format according to an exemplary embodiment of the present invention. The MIKEY 300 includes fields. Among them, EXTension Multimedia Broadcast/Multicast Service (EXT MBMS) 310 has Key Domain ID and Key Type ID. The Key Type ID indicates an MSK ID, including Key Group Part and Key Number Part.

If an SMS message is used to indicate the presence of an updated MSK, it includes a MIKEY having the format illustrated in FIG. 3. In accordance with the present invention, the ID of the MSK to be updated is indicated to the terminal 30 by changing the MSK ID in the EXT MBMS field 310. Specifically, while part of the MIKEY format is used when data is transmitted by a conventional SMS message, the SMS message of the present invention includes the MIKEY illustrated in FIG. 3 to notify the presence of an MSK to be updated.

For example, if the terminal receives a MIKEY with KEY Domain ID set to 1 and MSK ID set to 0, it transmits an MSK Request message with Key Number Part of MSK ID being also 0 to request a current MSK to the server in the conventional technology. In comparison, when the terminal receives a MIKEY with KEY Domain ID set to 1 and MSK ID set to 1, it can requests the MSK indicated by the server, i.e. the updated MSK based on the MSK ID by an MSK Request message.

When an SMS message is used to indicate the presence of an MSK to be updated, a MIKEY included in the SMS message may not provide a coded data area in KEMAC 330. That is, the server 40 can transmit an SMS message to the terminal 30 by adopting the MIKEY format excluding KEMAC 330 because it has only to indicate the ID of the MSK to be updated.

On the other hand, if the overall size of a MIKEY including KEMAC 330 is small, the server 40 can transmit an SMS message including an updated MSK in the form of the MIKEY directly to the terminal 30. Hence, the SMS message can carry an updated MSK as well as indicate the presence of an MSK to be updated.

When receiving the SMS message for MSK update, the terminal 30 can transmit an MSK Request message. However, if the terminal 30 determines that the updated MSK is required, it can request the updated MSK without receiving the SMS message. In accordance with a third exemplary embodiment of the present invention, when the terminal itself transmits an MSK Request message, the server provides an MSK to the terminal by an MSK Response message.

Steps 220 to 226 of FIG. 2 correspond to the third exemplary embodiment of the present invention. When a TV application starts or the terminal 30 is power-on in step 220, the terminal 30 transmits an MSK Request message including a current MSK to the server 40 in step 222. The MSK Request message can be used to query about whether the terminal 30 has failed to receive a necessary MSK in an exceptional case or whether there is a new updated MSK. To indicate the current MSK that it preserves, the terminal 30 transmits the MSK Request message including the current MSK. After authentication in step 224, if there is an updated MSK other than the current MSK, the server 40 transmits an MSK Response message including the updated MSK in the form of a MIKEY to the terminal 30 in step 226. Conventionally, although the terminal requests an MSK by an MSK Request message, it can receive the MSK from the server only by the UDP. Compared to the conventional technology, the terminal 30 can receive the MSK by the MSK Response message without using the UDP in the third exemplary embodiment of the present invention.

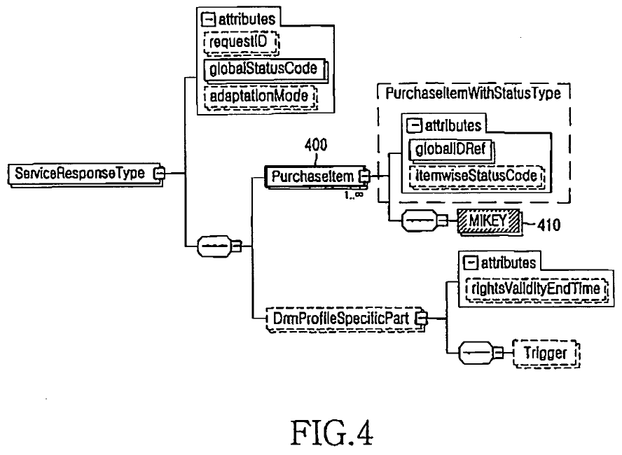

With reference to FIG. 4, a MIKEY included in a Service Response message according to an exemplary embodiment of the present invention will be described. FIG. 4 illustrates a tree structure of ServiceResponseType in the Service Response message. A MIKEY 410 is base64-encoded in the Service Response message. Since the MIKEY 410 varies depending on a service to be purchased, preferably, it is included in PurchaseItem 400 indicating a service item to be purchased in FIG. 4.

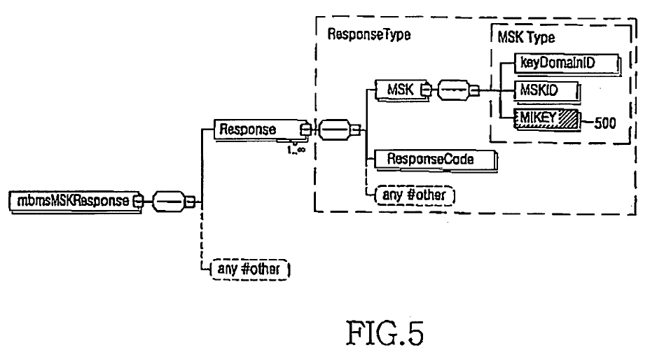

With reference to FIG. 5, a MIKEY included in an MSK Response message according to an exemplary embodiment of the present invention will be described. FIG. 5 illustrates a tree structure of the MSK Response message according to an exemplary embodiment of the present invention. A MIKEY 500 is base64-encoded in the MSK Response message. Since one MIKEY is allocated per MSK ID, the MIKEY 500 is mapped to an MSK ID in FIG. 5.

When a service is purchased on the Web, the terminal receives a Smart Card Profile Trigger message, thus completing the purchase. Then, the terminal transmits an MSK Request message to directly request an MSK based on information included in the Smart Card Profile Trigger message. If registration is successful, the terminal acquires the MSK by an MSK Response message. When canceling the purchase, the terminal transmits an Unsubscribe Request message including the ID of the service to be canceled to the server. The server replies to the terminal with an Unsubscribe Response message. If this procedure is successful, the server does not provide any further information about an updated MSK to the terminal by an SMS message.

As is apparent from the above description, the present invention involves a service purchase step, an SMS trigger step, an MSK request step, a purchase cancel step, and a Web-based purchase step, by and large. Compared to the conventional technology, since the present invention does not carry out service registration and deregistration, an overall MSK acquisition process becomes fast. Also, there is no need for keeping a connection between a terminal and a server after the terminal is powered off or the purchased service ends. Therefore, network resource consumption is prevented and an unnecessary service charge is not billed.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A key providing method for a portable broadcasting system having a terminal and a server, comprising:
transmitting, by the terminal, when a service is selected after a broadcasting application is invoked, a service request message including information about the selected service;
receiving, by the terminal, a service response message including a key required for using the selected service in the form of a Multimedia Internet KEYing (MIKEY) from the server.

2. The key providing method of claim 1, further comprising:
receiving, by the terminal, a Short Message Service (SMS) message including key information about an updated key from the server when the key is updated;
transmitting, by the terminal, a key request message requesting the updated key based on the key information; and
receiving, by the terminal, a key response message including the updated key in the form of a MIKEY from the server.

3. The key providing method of claim 2, wherein the key information is a Multimedia Broadcast/Multicast Service (MBMS) Service Key Identifier.

4. The key providing method of claim 1, further comprising:
transmitting, by the terminal, a key request message including current key information about a current key when the terminal needs to update the key; and
receiving, by the terminal, a key response message including an updated key based on the current key information in the form of a MIKEY.

5. The key providing method of claim 1, wherein the key required for using the service is a Multimedia Broadcast/Multicast Service (MBMS) Service Key.

6. The key providing method of claim 1, wherein the service request message and the service response message are transmitted by a Hypertext Transfer Protocol (HTTP).

7. The key providing method of claim 2, wherein the key request message and the key response message are transmitted by a Hypertext Transfer Protocol (HTTP).

8. A portable broadcasting system, comprising:
a terminal for transmitting, when a service is selected after a broadcasting application is invoked, a service request message including information about the selected service; and
a server for transmitting a service response message including a key required for using the selected service in the form of a Multimedia Internet KEYing (MIKEY) to the terminal.

9. The portable broadcasting system of claim 8, wherein, when the key is updated, the server transmits a Short Message Service (SMS) message including key information about an updated key to the terminal, and transmits a key response message including the updated key in the form of a MIKEY to the terminal, upon receipt of a key request message requesting the updated key based on the key information from the terminal.

10. The portable broadcasting system of claim 9, wherein the key information is a Multimedia Broadcast/Multicast Service (MBMS) Service Key Identifier.

11. The portable broadcasting system of claim 8, wherein the terminal transmits a key request message including current key information about a current key when the terminal needs to update the key, and receives a key response message including an updated key based on the current key information in the form of a MIKEY from the server.

12. The portable broadcasting system of claim 8, wherein the key is a Multimedia Broadcast/Multicast Service (MBMS) Service Key.
